(19) United States
(12) Patent Application Publication
(10) Pub. No.: US 2009/0141901 A1
(43) Pub. Date: Jun. 4, 2009

(54) TERMINAL AND METHOD OF INCLUDING PLURALITY OF CONDITIONAL ACCESS APPLICATIONS IN BROADCASTING SYSTEM

(76) Inventors: Woongshik YOU, Chungcheongnam-Do (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/181,605

(22) Filed: Jul. 29, 2008

(30) Foreign Application Priority Data
Nov. 30, 2007 (KR) 10-2007-0123890

(51) Int. Cl. H04L 9/00

(52) U.S. Cl. 380/277

(57) ABSTRACT

A method of selectively using a CA application of a terminal, the method including: searching a CA application table when a service of fee-based contents is requested, and determining whether a corresponding CA application is installed; and extracting a key required for descrambling a broadcasting signal using the CA application, when the CA application is installed based on a result of the determining.

### CROSS-REFERENCE TO RELATED APPLICATION

This application claims the benefit of Korean Patent Application No. 10-2007-0123890, filed on Nov. 30, 2007, in the Korean Intellectual Property Office, the disclosure of which is incorporated herein by reference.

### BACKGROUND OF THE INVENTION

1. Field of the Invention

The present invention relates to a terminal and method of including a plurality of Conditional Access (CA) applications in a broadcasting system, and more particularly, to a broadcast receiving apparatus and method of searching and providing a CA application corresponding to a broadcasting from among a plurality of CA applications stored in the broadcast receiving apparatus.

This work was supported by the IT R&D program of MIC/IITA. [2007-S-007-01, The development of downloadable conditional access system]

2. Description of Related Art

A Conditional Access System (CAS) provides an authority for only subscribed clients to watch fee-based contents by encrypting a broadcasting program, which is indispensable to a fee-based broadcasting such as cable broadcasting and satellite broadcasting. In a CAS, a CA application is essential to encrypt/decrypt a key required for scrambling/descrambling fee-based contents.

In general, in fee-based broadcasting service, a single service provider is provided with contents from a plurality of contents providers, and scrambles and transmits fee-based contents using a key generated in a single CA application. Keys used for scrambling are encrypted using a CA application and transmitted separately from contents to a subscriber terminal. Also, a subscriber terminal extracts a necessary key using a CA application installed in the subscriber terminal and descrambles fee-based contents using the key.

Currently, however, a broadcasting service and communication service are converging, and a new communication/broadcasting convergence service such as a real-time Internet Protocol Television (IPTV) is provided. Accordingly, a subscriber may be provided with fee-based contents from a plurality of service providers using different CA applications rather than being provided with a service from a single service provider using a single CA application. In fee-based contents using a single CA application, a subscriber terminal requires a single CA application to descramble contents. However, in fee-based contents using a plurality of service providers using different CA applications, a plurality of CA applications is required to be installed in a subscriber terminal, and a CA application for each content is required to be used for descrambling.

Thus, an apparatus and method which manages a plurality of received CA applications, searches and provides a CA application corresponding to a broadcasting when a fee-based broadcasting is requested is required.

### BRIEF SUMMARY

The present invention provides a terminal and method of including a plurality of Conditional Access Systems (CASs) in a broadcasting system.

The present invention also provides a broadcast receiving apparatus and method of searching and providing a CA application corresponding to a broadcasting from among a plurality of CA applications stored in the broadcast receiving apparatus.

The present invention also provides a broadcast receiving apparatus and method which searches a CA application corresponding to a broadcasting from among a plurality of CA applications stored in the broadcast receiving apparatus, and when the CA application does not exist based on a result of the searching, connects to a CA server to be provided with the CA application.

According to an aspect of the present invention, there is provided a terminal, including: a secure micro extracting a key required for descrambling a broadcasting signal using a selected Conditional Access (CA) application; and a control unit, when a service of fee-based contents is requested, searching a CA application table, and when a corresponding CA application is installed in the secure micro, requesting the secure micro for a selection on the CA application.

According to another aspect of the present invention, there is provided a method of selectively using a CA application of a terminal, the method including: searching a CA application table when a service of fee-based contents is requested, and determining whether a corresponding CA application is installed; and extracting a key required for descrambling a broadcasting signal using the CA application, when the CA application is installed based on a result of the determining.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram illustrating a broadcasting system including a terminal with a plurality of Conditional Access Systems (CASs) according to an embodiment of the present invention; and

FIG. 2 is a flowchart illustrating a method of providing fee-based contents in a terminal with a plurality of CASs according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

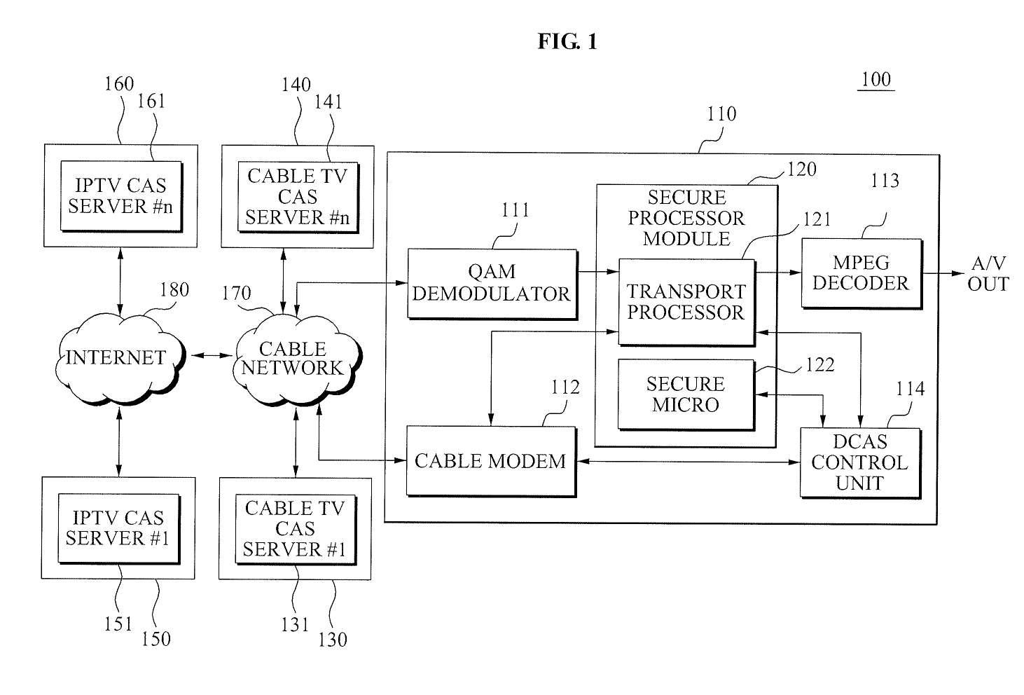

According to an embodiment of the present invention, a broadcast receiving apparatus and method searches and provides a Conditional Access (CA) application corresponding to a broadcasting from among a plurality of CA applications stored in the broadcast receiving apparatus when receiving a fee-based broadcasting. Hereinafter, a broadcasting system including the broadcast receiving apparatus is described in detail with reference to FIG. 1.

FIG. 1 is a block diagram illustrating a broadcasting system 100 including a terminal 110 with a plurality of Conditional Access Systems (CASs) according to an embodiment of the present invention.

Referring to FIG. 1, the broadcasting system 100 includes a terminal 110 of a subscriber for a downloadable CAS (DCAS), cable headends 130 and 140 and CAS servers 131 and 141 for a fee-based cable broadcasting, and Internet Protocol Television (IPTV) headends 150 and 160 and IPTV CAS servers 151 and 161 for a fee-based IPTV broadcasting.

The terminal 110 includes a secure processor module 120, a Quadrature Amplitude Modulation (QAM) demodulator 111, a cable modem 112, a Moving Picture Experts Group (MPEG) decoder 113, and a DCAS control unit 114. The QAM demodulator 111 performs a broadcasting channel tuning and QAM demodulation. The cable modem 112 provides a communication channel of a cable network. The MPEG decoder 113 restores a compressed audio/video signal. The DCAS control unit 114 controls each block of the terminal 110 and performs routing with respect to a message to be transmitted to each block. The secure processor module 120 includes a Transport Processor (TP) 121 and Secure Micro (SM) 122. The TP 121 descrambles fee-based contents. The SM 122 stores a plurality of CA applications and CA application table. The CA application table may also be stored in a memory unit, not illustrated, instead of the SM 122. The memory unit is controlled by the DCAS control unit 114.

When the terminal 110 is connected to a cable network 170 and Internet 180, the SM 122 in the secure processor module 120 authenticates the secure processor module 120. Specifically, the authentication is performed between the SM 122 of the terminal 110 and an authentication server included in a headend of a cable or IPTV broadcasting service provider. The cable modem 112 of the terminal 110 provides a communication channel with a cable or IPTV headend. The DCAS control unit 114 controls a message to be transmitted/received from/to the authentication server via the SM 122. The message is required for the authentication. When the authentication is completed, a CA application is downloaded from the cable headend or IPTV headend to the SM 122. The downloaded CA application is operated, and the operated CA application provides key information, a scrambling scheme, initialization information, and the like to enable the TP 121 to descramble scrambled broadcasting data. The key information is required for descrambling scrambled broadcasting data. The descrambled data is restored as an audio/video signal in the MPEG decoder 113, and thus the subscriber may watch a fee-based broadcasting.

When a service is provided from a single broadcasting service provider, the fee-based contents service may be available using a single CA application as described above. However, according to an embodiment of the present invention, when the terminal 110 is provided with the service from a plurality of cable or IPTV service providers, a plurality of CA applications are required. When a service of the fee-based contents is requested, the DCAS control unit 114 of the terminal 110 determines whether a CA application used by a corresponding service provider is installed in the terminal 110 using the CA application table stored in the SM 122 or memory unit. The CA application table is described in detail with reference to Table 1. When the CA application is already installed, the CA application is used. When the CA application is not installed, the DCAS control unit 114 downloads and installs the CA application through a communication with a headend of the corresponding service provider, and updates the CA application table. The DCAS control unit 114 extracts key information using the installed CA application. The key information is required to descramble the scrambled broadcasting data.

TABLE 1

| | | CA | CA |
|---|---|---|---|
| Field | CAS server address | application ID | application version |
| Value | IPv4 or IPv6 address | 16 bit ID | 32 bit ID |
| Example | 129.254.254.254 | 0x23af | 0x00000001 |

A configuration of the CA application table is illustrated in Table 1. The CA application table includes a CAS server address field, CA application ID field, and CA application version field. That is, when contents to be provided is fee-based contents and a CA application for the contents is required, the DCAS control unit 114 of the terminal 110 confirms the CAS server address field, CA application ID field, and CA application version field in the CA application table and determines whether a corresponding CA application is installed.

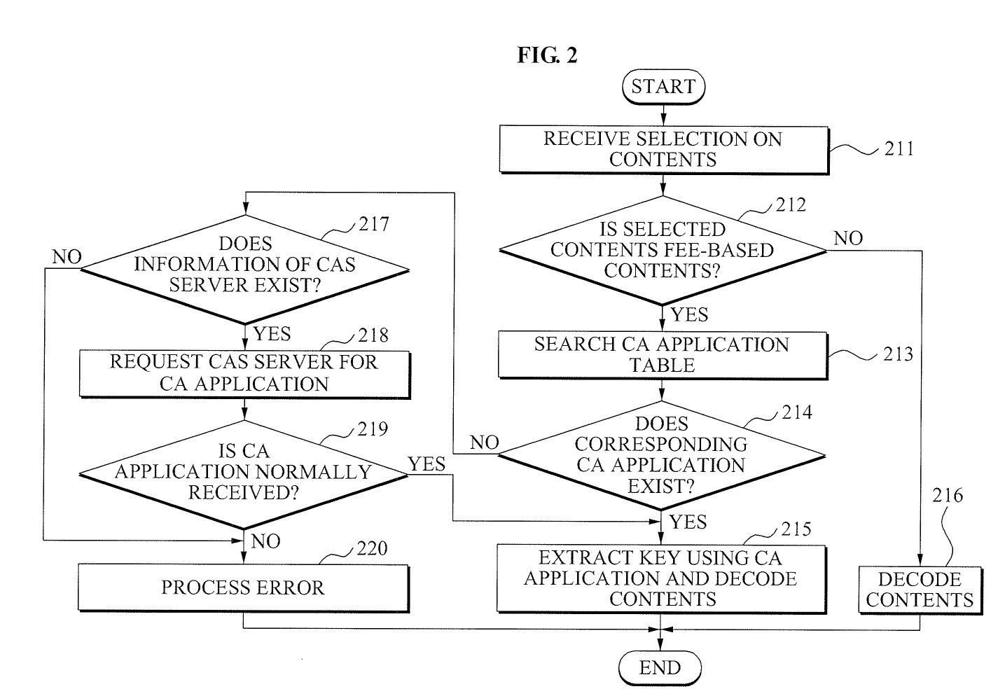

Hereinafter, in a broadcasting system 100, when a service of fee-based contents is used in a terminal with a plurality of CA applications, a method of selectively using the CA application is described in detail with reference to FIG. 2.

FIG. 2 is a flowchart illustrating a method of providing fee-based contents in a terminal with a plurality of CASs according to an embodiment of the present invention.

Referring to FIG. 2, a terminal receives a selection on contents from a subscriber in operation 211. The terminal determines whether the selected contents are fee-based contents requiring CA descrambling in operation 212. When the selected contents are free contents based on a result of the determining, the terminal decodes the selected contents in operation 216 and ends an algorithm of the present invention.

When the selected contents are fee-based contents based on the result of the determining in operation 212, the terminal searches a CA application table in operation 213. The CA application is used to extract key information required for descrambling the selected contents. The terminal determines whether a corresponding CA application exists in the CA application table in operation 214. When the CA application exists based on a result of the determining in operation 214, the terminal extracts key information for the fee-based contents using the CA application and decodes the fee-based contents in operation 215.

When the CA application does not exist in the CA application table based on the result of the determining in operation 214, the terminal determines whether information of a corresponding CAS server exists in the terminal in operation 217. In operation 217, the information of the CAS server is received when the fee-based contents are selected, or received from the CAS server through a broadcasting.

When the information of the CAS server exists based on a result of the determining in operation 217, the terminal requests the CAS server for the CA application in operation 218. Also, the terminal determines whether the CA application is normally received in operation 219. When the CA application is normally received based on a result of the determining in operation 219, the terminal returns to operation 215 to extract the key information for the fee-based contents using the CA application, decode the fee-based contents, and end the algorithm. Also, when the CA application is normally received based on a result of the determining in operation 219, the terminal updates the CA application table to include information about the received CA application.

When the information of the CAS server does not exist based on the result of the determining in operation 217 or the CA application is not normally received based on the result of the determining in operation 219, the terminal processes an error in operation 220. When processing the error in operation 220, the information of the CAS server may be searched again or an error message corresponding to a generated error may be outputted.

According to an embodiment of the present invention, a terminal and method of including a plurality of Conditional Access Systems (CASs) in a broadcasting system is provided.

Also, according to an embodiment of the present invention, a broadcast receiving apparatus and method of searching and providing a CA application corresponding to a broadcasting from among a plurality of CA applications stored in the broadcast receiving apparatus is provided.

Also, according to an embodiment of the present invention, a broadcast receiving apparatus and method searches a CA application corresponding to a broadcasting from among a plurality of CA applications stored in the broadcast receiving apparatus, and when the CA application does not exist based on a result of the searching, connects to a CA server to be provided with the CA application.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A terminal, comprising:
a secure micro extracting a key required for descrambling a broadcasting signal using a selected Conditional Access (CA) application; and
a control unit, when a service of fee-based contents is requested, searching a CA application table, and when a corresponding CA application is installed in the secure micro, requesting the secure micro for a selection on the CA application.

2. The terminal of claim 1, wherein, when the CA application does not exist based on a result of the searching, the control unit confirms information of a Conditional Access System (CAS) server, requests the CAS server for the CA application, installs the CA application in the secure micro when the CA application is received from the CAS server, and controls the secure micro to descramble using the CA application, the CAS server providing the CA application.

3. The terminal of claim 2, wherein, when the CA application is received from the CAS server, the control unit updates the CA application table to include information about the CA application.

4. The terminal of claim 1, wherein the CA application table is stored in the secure micro or a separate memory.

5. The terminal of claim 1, wherein the CA application table includes at least one of CAS server address information, CA application identifier (ID) information, and CA application version information.

6. A method of selectively using a CA application of a terminal, the method comprising:
searching a CA application table when a service of fee-based contents is requested, and determining whether a corresponding CA application is installed; and
extracting a key required for descrambling a broadcasting signal using the CA application, when the CA application is installed based on a result of the determining.

7. The method of claim 6, further comprising:
confirming information of a CAS server providing the CA application when the CA application is not installed based on a result of the determining;
requesting the CAS server for the CA application;
receiving the CA application from the CAS server; and
extracting the key required for descrambling using the received CA application.

8. The method of claim 7, further comprising:
updating the CA application table to include information about the CA application after receiving the CA application.

9. The method of claim 6, wherein the CA application table includes at least one of CAS server address information, CA application ID information, and CA application version information.
